(19) United States
(12) Patent Application Publication
(10) Pub. No.: US 2009/0304417 A1
(43) Pub. Date: Dec. 10, 2009

(54) IMAGE FORMING APPARATUS

(75) Inventor: Mutsumi Inoue, Osaka-shi (JP)

Correspondence Address: CASELLA & HESPOS, 274 MADISON AVENUE, NEW YORK, NY, 10016, US

(73) Assignee: KYOCERA MITA CORPORATION, Osaka-shi (JP)

(21) Appl. No.: 12/476,714

(22) Filed: Jun. 2, 2009

(30) Foreign Application Priority Data
Jun. 5, 2008 (JP) 2008-148448

(51) Int. Cl. G03G 15/01

(52) U.S. Cl. 399/301; 399/302

(57) ABSTRACT

An image forming apparatus has: an image forming section that forms a toner image corresponding to image information; an intermediate transfer belt, which is an endless belt stretched between a plurality of rollers and traveling between the plurality of rollers, the toner image being transferred to a surface thereof or a recording sheet placed on the surface thereof; a driving roller, which is one of the plurality of rollers and drives the intermediate transfer belt; a bending roller, which touches an outer circumferential surface of the intermediate transfer belt and presses and bends the intermediate transfer belt in an inner circumferential direction; and a speed detecting part which detects a movement speed of an outer circumference of the intermediate transfer belt by measuring a rotational speed of the bending roller.

### BACKGROUND OF THE INVENTION

1. Field of the Invention

The present invention relates to an image forming apparatus that has an intermediate transfer belt.

2. Description of the Related Art

An image forming apparatus, such as a laser printer and a copy machine, which employs a xerography, has rotating members such as a photosensitive drum, a transfer roller, and an intermediate transfer belt. These rotating members are used for outputting a toner image onto a recording sheet through an electrostatic latent image formation process. It is necessary to control these rotating members accurately, in order to obtain an output result without causing a density fluctuation and image displacement. Especially because the toner image which is output onto the recording sheet is transferred to the intermediate transfer belt, the speed of movement of the intermediate transfer belt needs to be measured accurately and controlled constantly. Particularly, in a tandem system image forming apparatus, inconstant movement speed of the intermediate transfer belt causes displacement of the transfer position of a toner image of each color and a color registration error. This is because the tandem system image forming apparatus sequentially superposes the toner image of each color on the intermediate transfer belt and transfers these toner images.

As a conventional method of measuring the movement speed of an intermediate transfer belt, there is a method of measuring the movement speed of the intermediate transfer belt by forming a mark on an inner circumferential surface of the intermediate transfer belt and reading this mark using a sensor disposed in an inner circumference of the intermediate transfer belt (see, for example, Japanese Patent Application Publication No. 2007-71781). As another method, there is also known a method of measuring the movement speed of the intermediate transfer belt by using an encoder or the like to measure the rotational speed of at least one of a plurality of rollers touching the inner circumferential surface of the intermediate transfer belt and stretched between and supporting the intermediate transfer belt. Either way, the conventional methods measure the movement speed of the intermediate transfer belt by measuring the speed of the inner circumferential surface of the intermediate transfer belt.

However, because of the thickness of the intermediate transfer belt, the movement speed of the inner circumferential surface is different from the movement speed of an outer circumferential surface to which the toner images are actually transferred. For this reason, in the method of the conventional technology that measures the speed of the inner circumferential surface of the intermediate transfer belt, the movement speed of the inner circumferential surface is converted to the movement speed of the outer circumferential surface in consideration of the thickness of the intermediate transfer belt. However, when the thickness of the intermediate transfer belt is uneven due to a dimension error caused during the production of the intermediate transfer belt, or when a part of the intermediate transfer belt is stretched as a result of time degradation of the intermediate transfer belt, the speed conversion cannot be performed accurately. Consequently, the conventional methods for detecting the speed of the inner circumferential surface of the intermediate transfer belt lacks in accuracy of measuring and controlling the speed of the intermediate transfer belt.

### SUMMARY OF THE INVENTION

An object of the present invention is to provide an image forming apparatus that is capable of accurately measuring the movement speed of an intermediate transfer belt to be controlled, in order to output an image with no density fluctuation and color registration error by accurately controlling the movement speed of the intermediate transfer belt of the image forming apparatus.

In order to achieve this object, an image forming apparatus according to one aspect of the present invention has: an image forming section that forms a toner image corresponding to image information; an intermediate transfer belt, which is an endless belt stretched between a plurality of rollers and traveling between the plurality of rollers, the toner image being transferred to a surface thereof or a recording sheet placed on the surface thereof; a driving roller, which is one of the plurality of rollers and drives the intermediate transfer belt; a bending roller, which touches an outer circumferential surface of the intermediate transfer belt and presses and bends the intermediate transfer belt in an inner circumferential direction; and a speed detecting part which detects a movement speed of an outer circumference of the intermediate transfer belt by measuring a rotational speed of the bending roller.

### BRIEF DESCRIPTION OF THE DRAWINGS

FIG. 1 is a cross-sectional diagram for explaining an internal structure of an image forming apparatus according to an embodiment of the present invention;

FIG. 2 is a diagram showing a transfer unit part shown in FIG. 1;

FIG. 3 is a diagram schematically showing a speed detection control mechanism according to the embodiment of the present invention;

FIG. 4 is a perspective view showing an arrangement of an encoder plate and an optical sensor;

FIG. 5 is a cross-sectional diagram showing a cross section taken along the line V-V shown in FIG. 4; and

FIG. 6 is an enlarged view showing the circumference of a bending roller touching an outer circumferential surface of an intermediate transfer belt, and the circumference of a support roller touching an inner circumferential surface of the intermediate transfer belt.

### DETAILED DESCRIPTION OF THE PREFERRED EMBODIMENTS

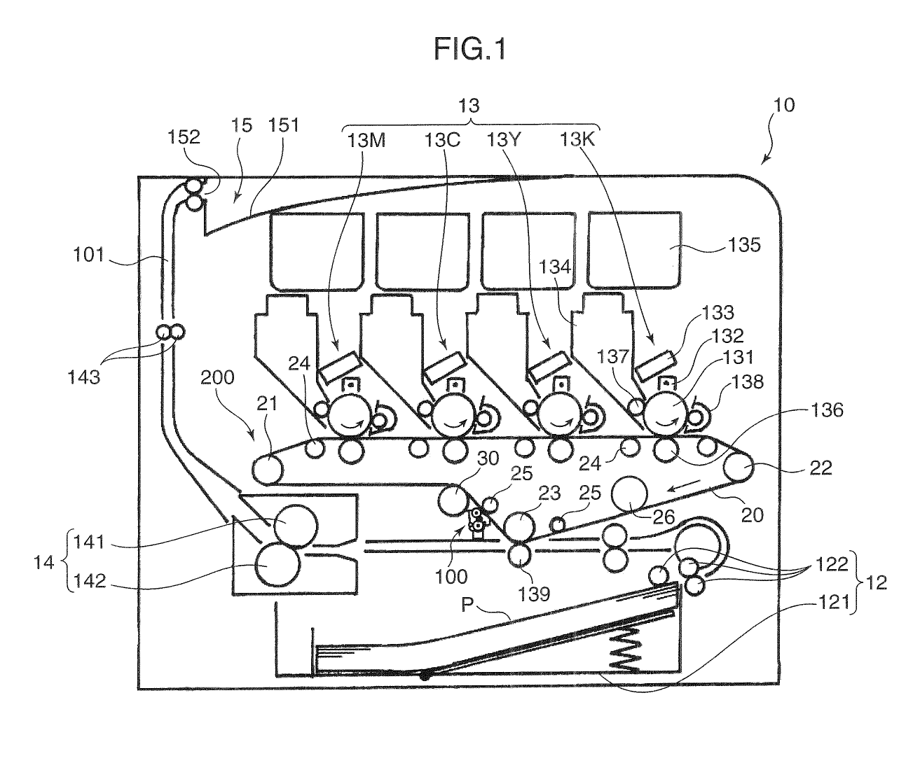

FIG. 1 is a cross-sectional diagram for explaining an internal structure of an image forming apparatus according to an embodiment of the present invention. In the present embodiment, a printer 10 is adopted as the image forming apparatus. The printer 10 has a paper feed section 12, an image forming section 13, a fixation section 14, and a paper ejection section 15. The paper feed section 12 stores a stack of papers P (recording sheets). The image forming section 13 transfers a toner image corresponding to image information onto each of the papers P conveyed from the paper feed section 12. The fixation section 14 performs fixation processing on the toner image that is transferred onto each sheet of paper P by the image forming section 13. The paper ejection section 15 ejects the paper P subjected to the fixation processing by the fixation section 14.

The paper feed section 12 has a paper cassette 121 and a pickup roller 122. The paper cassette 121 is insertably mounted in a lower part of the printer 10 and stores a plurality of sheets of paper P therein. The pickup roller 122 is provided in a position on the upper right side of the paper cassette 121 as shown in FIG. 1. The paper P stored in the paper cassette 121 are picked up one by one by driving the pickup roller 122, and sent toward the image forming section 13.

In the image forming section 13, a magenta unit 13M using a magenta (M) toner, a cyan unit 13C using a cyan (C) toner, a yellow unit 13Y using a yellow (Y) toner, and a black unit 13K using a black (K) toner are arranged in parallel.

Each of the units 13M, 13C, 13Y and 13K is provided with a photosensitive drum 131, a charger 132, an exposure device 133, a developing device 134, a toner container 135, a primary transfer roller 136, and a drum cleaning device 138. The image forming section 13 is provided with an intermediate transfer belt 20 and a secondary transfer roller 139 as the members shared by the units 13M, 13C, 13Y and 13K.

Each of the photosensitive drum 131 forms an electrostatic latent image and a toner image corresponding to this electrostatic latent image, on a circumferential surface of the photosensitive drum 131. The photosensitive drum 131 rotates in a counterclockwise direction in FIG. 1 to be supplied with toner from the corresponding developing device 134.

The charger 132 has a charging wire for performing charging processing on the circumferential surface of the photosensitive drum 131 to form a uniform charge on this circumferential surface. High voltage is applied to this charging wire by a power source, not shown, and the uniform charge is formed on the circumferential surface of the photosensitive drum 131 by a corona discharge generated by the application of the high voltage. In place of the charger 132, the charging roller applied with high voltage may be caused to touch the circumferential surface of the photosensitive drum 131, and consequently a charge may be formed on the circumferential surface of the photosensitive drum 131.

The exposure device 133 irradiates the circumferential surface of the photosensitive drum 131 charged uniformly by the charger 132, with a laser beam based on image data that is input from a computer or the like (not shown). This laser beam irradiation forms the electrostatic latent image on the circumferential surface of the photosensitive drum 131. The toner is supplied from the developing device 134 to this electrostatic latent image, whereby a toner image is formed on the circumferential surface of the photosensitive drum 131 and then transferred to the rotating intermediate transfer belt 20.

The developing device 134 supplies the toner to the circumferential surface of the photosensitive drum 131 having the electrostatic latent image formed thereon, and thereby forms a toner image on the circumferential surface. The developing device 134 is provided with a stirring/conveying member therein, and a developing roller 137, a circumferential surface of which faces the circumferential surface of the photosensitive drum 131 at the lowermost position of the developing device 134. The toner is supplied to the circumferential surface of the photosensitive drum 131 as the developing roller 137 rotates.

The toner container 135 is mounted detachably with respect to each developing device 134 and supplies the toner to the developing device 134. The primary transfer roller 136 peels the toner image from the photosensitive drum 131 electrostatically and transfers the toner image onto the surface of the intermediate transfer belt 20 that is described hereinafter. The drum cleaning device 138 performs cleaning processing on the circumferential surface of the photosensitive drum 131 after the toner image is transferred to the intermediate transfer belt 20.

An upper part of the intermediate transfer belt 20 touches each photosensitive drum 131 at a lower position in the photosensitive drum 131. The toner image on the circumferential surface of each of the photosensitive drums 131 is transferred to the intermediate transfer belt 20. Specifically, the toner images formed on the circumferential surfaces of the photosensitive drums 131 of the units 13M, 13C, 13Y and 13K are sequentially transferred in the form of layers to the surface of the intermediate transfer belt 20, whereby a color image is formed. The secondary transfer roller 139 peels the toner images from the intermediate transfer belt 20 electrostatically and transfers the toner images to the paper P sent from the paper feed section 12.

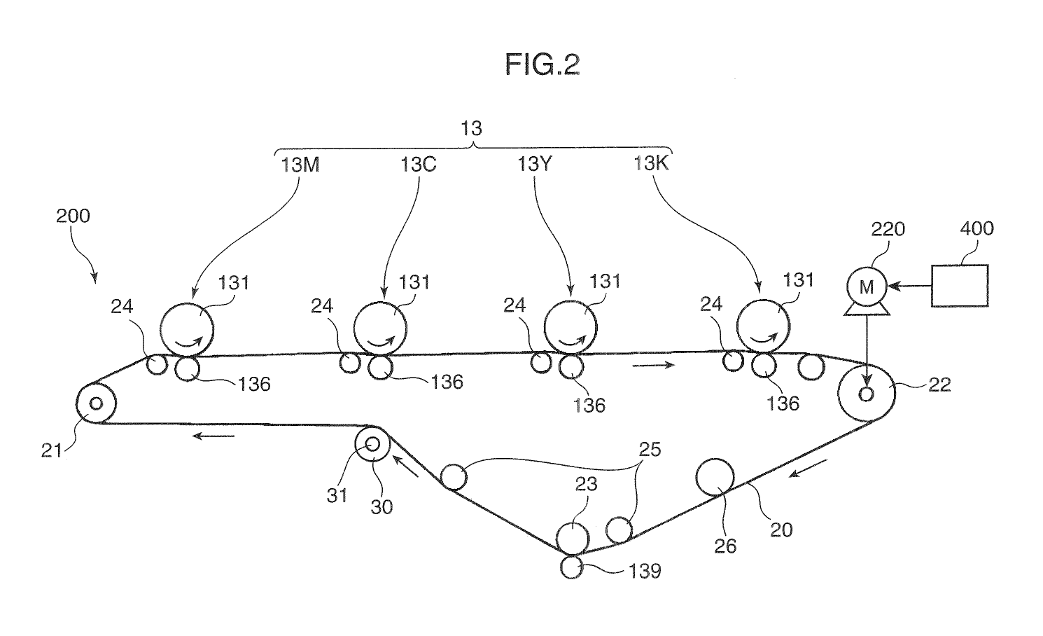

FIG. 2 is a diagram showing the intermediate transfer belt 20 shown in FIG. 1 and an extracted mechanism of the rollers and the like stretching the intermediate transfer belt 20 (to be referred to as “transfer unit” hereinafter). A transfer unit 200 has a driving roller 22, a support roller 21, a pressing roller 23, a driven roller 25, a tension roller 26, the intermediate transfer belt 20, and a bending roller 30.

The intermediate transfer belt 20 is stretched around the primary transfer roller 136 for each of the units 13M, 13C, 13Y and 13K, the support roller 21 provided slightly on the left-hand side of the primary transfer roller 136 of the unit 13M shown in FIG. 2, the driving roller 22 provided slightly on the right-hand side of the primary transfer roller 136 of the unit 13K shown in FIG. 2, the bending roller 30 disposed in the position substantially directly below the primary transfer roller 136 of the unit 13C on the right-hand side of the support roller 21 in the present embodiment and bends the intermediate transfer belt 20, and the pressing roller 23 disposed in the position substantially in the middle of and below the bending roller 30 and the driving roller 22.

The circumferential surfaces of the driving roller 22, support roller 21, pressing roller 23 and primary transfer roller 136 are all caused to touch an inner circumference of the intermediate transfer belt 20. The circumferential surface of the bending roller 30, on the other hand, is caused to touch an outer circumferential surface of the intermediate transfer belt 20.

The bending roller 30 is caused to touch the intermediate transfer belt 20 at a position slightly closer to the support roller 21 from the center of the lower outer circumference of the rotating intermediate transfer belt 20, and rotates about a rotation axis 31 disposed in the center of the bending roller 30, so as to follow the rotation of the intermediate transfer belt 20. The bending roller 30 is pressed and bent in the direction of the inner circumference of the intermediate transfer belt 20. Specifically, disposing the bending roller 30 makes it possible to create a space by pressing the intermediate transfer belt 20 inward. The internal volume of the printer 10 can be used effectively by utilizing this space.

The driving roller 22 touches the inner circumference side of the intermediate transfer belt 20 to drive the intermediate transfer belt 20. The roller driving motor 220 provides driving roller 22 with a drive force. Specifically, a torque generated by the roller driving motor 220 is transmitted to the driving roller 22 via a gear (not shown), whereby the driving roller 22 is driven. The rotating speed of the roller driving motor 220 is controlled by a drive controller 400 (controller).

The pressing roller 23 presses the intermediate transfer belt 20 against the secondary transfer roller 139. Therefore, the color image on the surface of the intermediate transfer belt 20 is securely transferred to the paper P that is conveyed while being held between the intermediate transfer belt 20 and the secondary transfer roller 139.

The secondary transfer roller 139 is pressed by the pressing roller 23 at the position immediately below the pressing roller 23, via the intermediate transfer belt 20. The secondary transfer roller 139 is applied with bias voltage by the power source, not shown, the bias voltage pealing the toner image from the intermediate transfer belt 20 electrostatically. Therefore, the toner image on the intermediate transfer belt 20 is transferred to the paper P passing between the intermediate transfer belt 20 and the secondary transfer roller 139.

In addition, an upper driven roller 24 is provided in on the left-hand side of each of the primary transfer roller 136, and the driven roller 25 is provided between the bending roller 30 and the pressing roller 23 and between the driving roller 22 and the pressing roller 23. The tension roller 26 is provided between the driving roller 22 and the driven roller 25. These upper and lower driven rollers 24 and 25 and the tension roller 26 keep a tension state by pressing the intermediate transfer belt 20 from the inside so that the intermediate transfer belt 20 does not sag.

A cleaning unit 100 for cleaning the surface of the intermediate transfer belt 20 after transfer processing is performed on the paper P is provided in the position facing the driven roller 25 on the left-hand side of FIG. 1 via the intermediate transfer belt 20. The intermediate transfer belt 20 cleaned by the cleaning unit 100 passes through the bending roller 30 to receive the next transfer processing, and is thereafter sent toward each of the photosensitive drum 131 of each of the units 13M, 13C, 13Y and 13K.

The fixation section 14 performs the fixation processing on the transferred image transferred onto the paper P by the image forming section 13. The fixation section 14 has a fixing roller 141 and a pressure roller 142. The fixing roller 141 is heated by an electric heat generator, such as a halogen lamp. The pressure roller 142 is disposed opposite to the fixing roller 141 on the lower side of the fixing roller 141, and a circumferential surface of the pressure roller 142 is brought into pressure abutment against a circumferential surface of the fixing roller 141. As shown in FIG. 1, the fixation section 14 is disposed in a space that is formed by the bending roller 30 pressing the intermediate transfer belt 20.

The paper P to which the toner image is transferred from the intermediate transfer belt 20 by the secondary transfer roller 139 is guided by the rotation of the intermediate transfer belt 20 while being held between the intermediate transfer belt 20 and the secondary transfer roller 139, and then introduced to the fixation section 14. The paper P is heated when passing through the space between the fixing roller 141 and the pressure roller 142, whereby the toner image is fixed to the paper P.

The paper P obtained the fixation processing moves up a paper ejection conveyance path 101 by means of the drive of a discharge roller pair 143, and is discharged to a catch tray 151 on the top of the printer 10 via a paper discharge port 152.

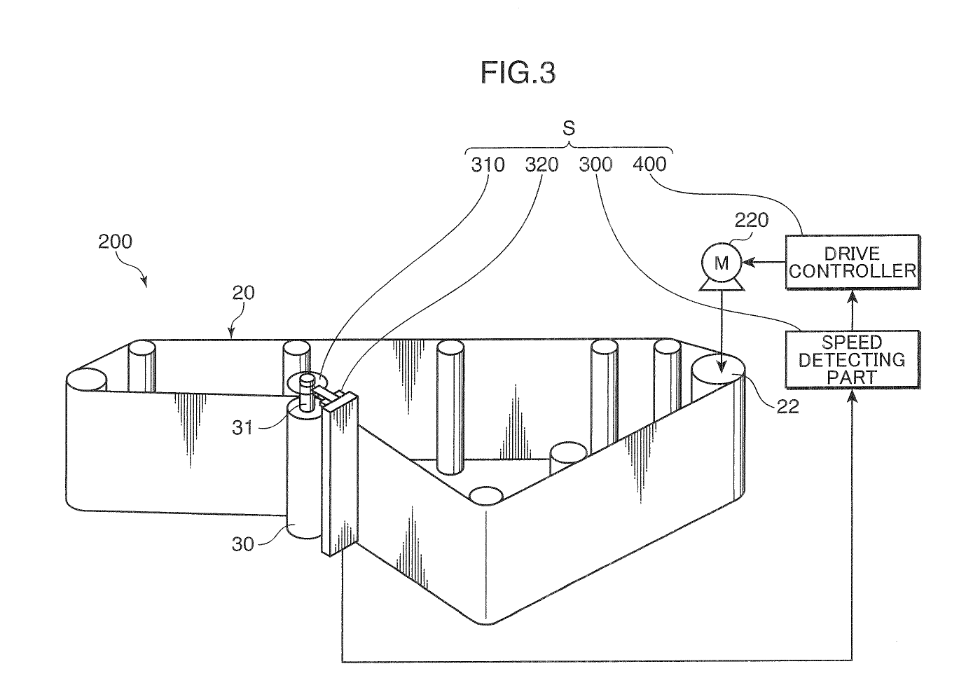

FIG. 3 is a diagram schematically showing a speed detection mechanism (speed detecting part) and a speed control mechanism (controller. To be referred to as “speed detection control mechanism” combined with the speed detecting part) according to an embodiment of the present invention. A speed detection control mechanism S has an encoder plate 310, an optical sensor 320, a speed detecting part 300 (speed detecting part), and a drive controller 400 (controller).

The encoder plate 310 is installed concentrically with the rotation axis 31 of the bending roller 30. The optical sensor 320 is installed such as to hold both surfaces of the encoder plate 310. The speed detecting part 300 detects the movement speed of the outer circumference of the intermediate transfer belt 20, by measuring the rotational speed of the bending roller 30 by using a measured value of the rotational speed of the encoder plate 310. The drive controller 400 controls the movement speed of the outer circumference of the intermediate transfer belt 20 driven by the driving roller 22, by controlling the rotating speed of the roller driving motor 220 that drives the driving roller 22.

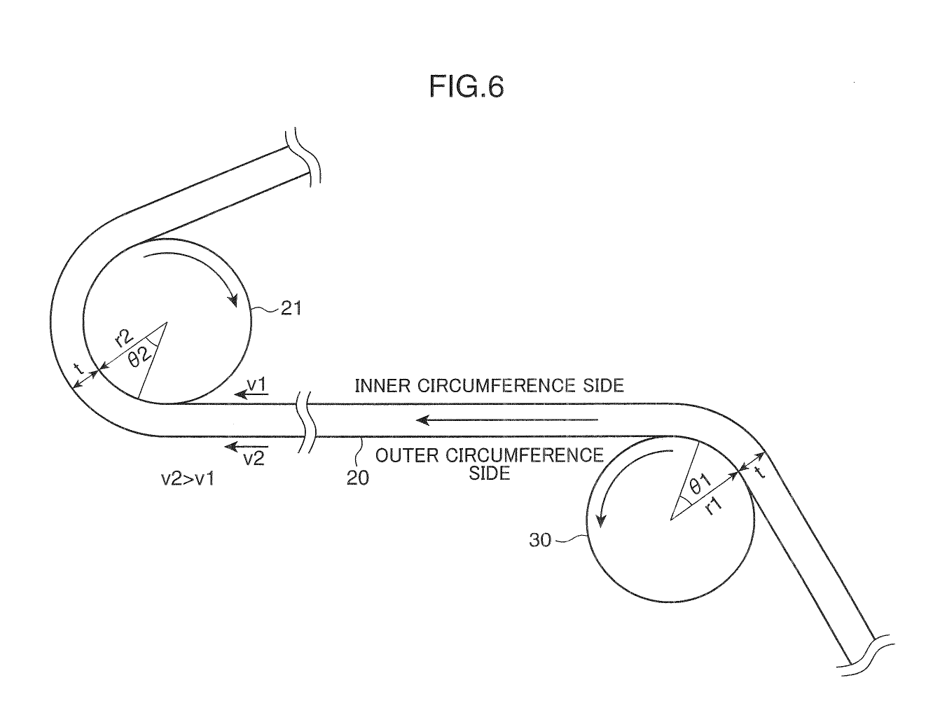

FIG. 6 is an enlarged view showing the circumference of the bending roller 30 touching the outer circumferential surface of the intermediate transfer belt 20, and the circumference of the support roller 21 touching the inner circumferential surface of the intermediate transfer belt 20. The intermediate transfer belt 20 has a predetermined thickness t. Therefore, the movement speed v2 of the outer circumferential surface of the intermediate transfer belt 20 to which the toner images are actually transferred is greater than the movement speed v1 of the outer circumferential surface of the intermediate transfer belt 20. Thus, when measuring the speed of the inner circumferential surface of the intermediate transfer belt 20 to control the movement speed of the intermediate transfer belt 20, the movement speed of the inner circumferential surface is converted to the movement speed of the outer circumferential surface in consideration of the thickness t of the intermediate transfer belt 20.

For example, suppose that the movement speed of the inner circumferential surface of the intermediate transfer belt 20 is measured based on the rotational speed of the support roller 21 touching the inner circumferential surface. The movement speed v2 of the outer circumferential surface can be expressed as v2=(r2+t)·θ2 when the support roller 21 with a radius r2 is rotated by θ2 radians per second. However, when the thickness t of the intermediate transfer belt 20 is uneven due to a dimension error caused during the production of the intermediate transfer belt 20, or when a part of the intermediate transfer belt 20 is stretched as a result of time degradation of the intermediate transfer belt 20, the movement speed of the outer circumference and the actual movement speed that are calculated in the above equation are different from each other. The difference results from calculating the movement speed v2 of the outer circumference, with the r2 and t taken as fixed values. For this reason, when measuring the speed of the inner circumferential surface of the intermediate transfer belt 20 to control the movement speed of the intermediate transfer belt 20, such a difference might lack in accuracy of controlling the speed of the intermediate transfer belt 20.

On the other hand, in the case of the present embodiment, the speed of the outer circumferential surface of the intermediate transfer belt 20 is obtained base on the rotational speed of the bending roller 30 touching the outer circumferential surface of the intermediate transfer belt 20. When the bending roller 30 having a radius of r1 is rotated by θ1 radians per second, the movement speed v2 of the outer circumferential surface can be expressed as v2=r1·θ1. In other words, the speed of the outer circumferential surface of the intermediate transfer belt 20 can be calculated regardless of the thickness t thereof.

As described above, because the speed detecting part 300 obtains the speed of the intermediate transfer belt 20 based on the rotational speed of the bending roller 30 touching the outer circumferential surface of the intermediate transfer belt 20, the movement speed of the outer circumference of the intermediate transfer belt 20 to which the toner images are transferred can be detected directly. As a result, the drive controller 400 can control, with a high degree of accuracy, the movement speed of the outer circumferential surface of the intermediate transfer belt 20 to which the toner images are transferred, and transfer the toner images to the intermediate transfer belt 20 accurately.

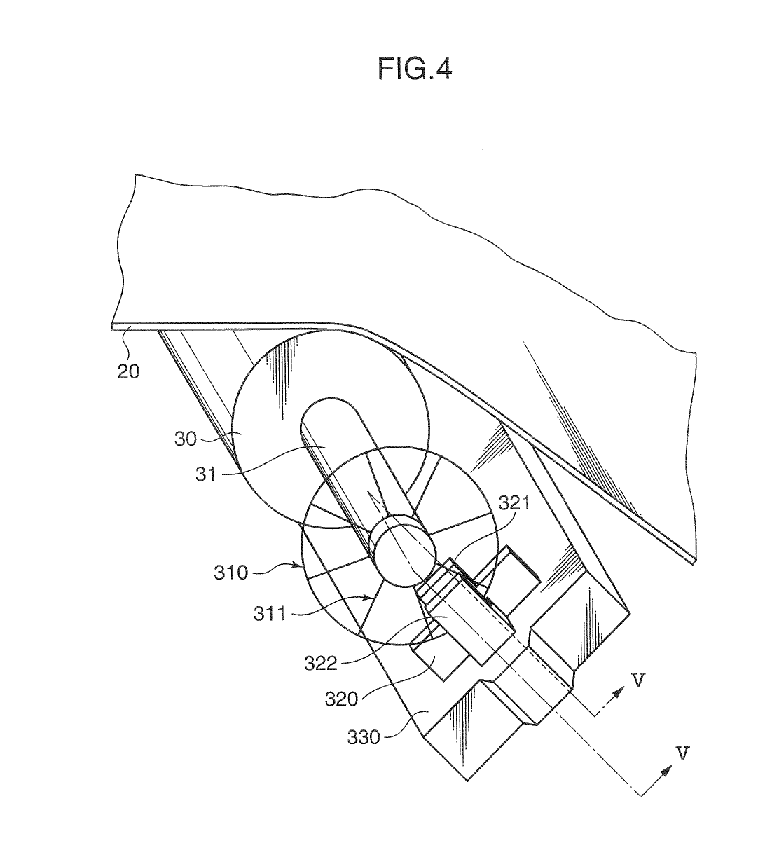

FIG. 4 is a perspective view showing an arrangement of the encoder plate 310 and the optical sensor 320. The encoder plate 310 is a circular disc made of a material having translucency for a wavelength of light emitted by the optical sensor 320. The encoder plate 310 is concentrically and fixedly attached to a part of the rotation axis 31 that protrudes from the bending roller 30, at an end of the bending roller 30. The encoder plate 310 rotates integrally with the rotation axis 31. On the surface of the encoder plate 310, shielding lines 311 are formed at equal intervals radially from the center of the encoder plate 310 toward the circumferential part thereof. The shielding lines 311 are described hereinafter in detail.

The optical sensor 320 is on the both side of the encoder plate, and projects/receives light transmitted through the encoder plate. The optical sensor 320 has a first protruding part 321 and a second protruding part 322 that face each other with a gap G therebetween. The encoder plate 310 is installed such that both surfaces thereof are held between the first protruding part 321 and the second protruding part 322.

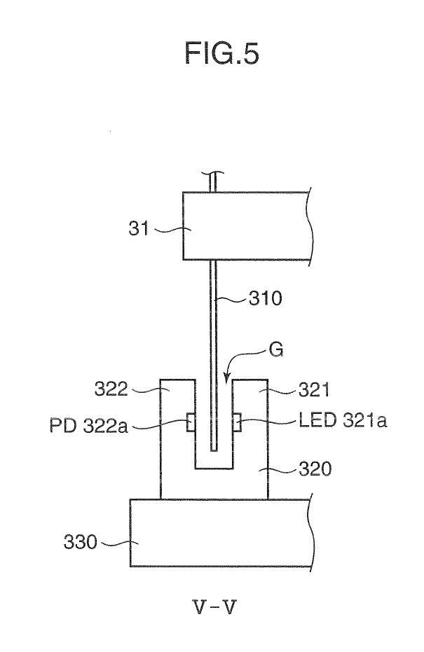

FIG. 5 is a cross-sectional diagram of the encoder plate 310 and optical sensor 320 shown in FIG. 4, the cross-sectional diagram being taken along the line V-V. A predetermined clearance is provided between the first protruding part 321 and the encoder plate 310, as well as between the encoder plate 310 and the second protruding part 322. The clearances are provided so that the rotation of the encoder plate 310 is not impeded by the optical sensor 320.

The optical sensor 320 has an LED (light-emitting diode) 321a on an inner surface of the first protruding part 321, and a PD (photo diode) 322a on an inner surface of the second protruding part 322. The LED 321a is an LED for emitting light of an infrared area, and radiates infrared light vertically toward the encoder plate 310 in a radial direction thereof. The PD 322a receives the infrared light radiated from the LED 321a and transmitted through the encoder plate 310. The PD 322a converts the received infrared light photoelectrically.

As shown in FIG. 4, the shielding lines 311 are formed at equal intervals radially from the center of the surface of the encoder plate 310 toward the circumferential part thereof. The shielding lines 311 do not have translucency for a wavelength of light emitted by the optical sensor 320 (the infrared area in the present embodiment). For this reason, when the LED 321a is positioned where the optical axis of the infrared light radiated toward the encoder plate 310 and the shielding lines 311 overlap on each other, the infrared light is shielded. Therefore, when the shielding lines 311 are placed in the gap G between the LED 321a and the PD 322a, the PD 322a does not receive the infrared light. When the shielding lines 311 are not placed in the gap G, the PD 322a receives the infrared light. As a result, electric signals that are generated by the PD 322a converting the infrared light photoelectrically become ON/OFF signals depending on the presence/absence of the light reception. The number of times that the signals are OFF represents the frequency at which the infrared light is shield by the shielding lines 311, and this shielding frequency is proportionate to the rotating speed of the bending roller 30. The electric signals generated by the PD 322a are output from the optical sensor 320 to the speed detecting part 300.

The optical sensor 320 is attached and fixed to an end of a sensor attachment support part 330. The attachment support part 330 is a column-like supporting member and disposed in parallel with the bending roller 30. Note that when the position of the optical sensor 320 relative to the encoder plate is shifted by a vibration such as the rotation of the bending roller 30, the shielding frequency described above cannot be detected accurately. Therefore, the sensor attachment support part 330 for fixing the optical sensor 320 is fixed to a frame of the strongly structured transfer unit 200.

The speed detecting part 300 is configured by a CPU (Central Processing Unit) and the like, and calculates the rotational speed of the encode plate 310 based on the electric signal output by the optical sensor 320. Here, the angular velocities of the rotations of the encoder plate 310 and of the bending roller 30 are the same, and the rotational speed of the outer circumference of the bending roller 30 is equal to the circulating speed of the outer circumference of the intermediate transfer belt 20 touching the bending roller 30. Therefore, the speed detecting part 300 can detect the movement speed of the outer circumference of the intermediate transfer belt 20 on the basis of the rotational speed of the encoder plate 310. Note that the greater the number of the shielding lines 311, the more the accuracy of the calculation of the movement speed of the outer circumference of the intermediate transfer belt 20 is improved.

The drive controller 400, configured by a CPU and the like, controls the rotating speed of the driving roller 22 by controlling the rotating speed of the roller driving motor 220 driving the driving roller 22. The drive controller 400 further increases and decreases the rotational speed of the roller driving motor 220 in response to a fluctuation in the movement speed of the outer circumference of the intermediate transfer belt 20 that is detected by the speed detecting part 300, to make the movement speed of the outer circumference of the intermediate transfer belt 20 constant.

The image formation process of the image forming apparatus according to an embodiment of the present invention is described hereinafter, with emphasis on the detection of the movement speed of the intermediate transfer belt 20 that is performed by the speed detection control mechanism S, as well as the control performed on the movement speed of the intermediate transfer belt 20.

The image data is input from the computer or the like into the printer 10. Once the printer 10 starts printing, the drive controller 400 activates the roller driving motor 220. The activation of the roller driving motor 220 causes the driving roller 22 touching the inner circumferential surface of the intermediate transfer belt 20 to rotate. When the driving roller 22 rotates, the intermediate transfer belt 20 is driven by a frictional force between the intermediate transfer belt 20 and the driving roller 22, and rotates and travels around a plurality of rollers stretching the intermediate transfer belt 20. The bending roller 30 that touches the outer circumferential surface of the intermediate transfer belt 20 and presses/bends the intermediate transfer belt 20 in the inner circumferential direction rotates about the rotation axis 31 disposed in the center, so as to follow the rotation of the intermediate transfer belt 20.

Once the bending roller 30 rotates, the encoder plate 310 disposed concentrically with the rotation axis 31 also rotates. Due to the rotation of the encoder plate 310, the infrared light radiated by the LED 321a toward the encoder plate 310 is shield intermittently by the shielding lines 311 that are formed at equal intervals radially toward the surface of the encoder plate 310. The PD 322a facing the LED 321a receives the infrared light intermittently. The electric signals that represent the frequency at which the infrared light is shield by the shielding lines 311 and that are generated by the PD 322a are output from the optical sensor 320 to the speed detecting part 300.

The speed detecting part 300 measures the rotational speed of the encoder plate 310 to obtain the rotational speed of the outer circumference of the bending roller 30, based on the electric signal representing the frequency at which the infrared light is shield by the shielding lines 311, and then calculates the movement speed of the outer circumference of the intermediate transfer belt 20 touching the bending roller 30.

The drive controller 400 increases and decreases the rotational speed of the roller driving motor 220 in response to a fluctuation in the movement speed of the outer circumference of the intermediate transfer belt 20 that is detected by the speed detecting part 300, to make the movement speed of the outer circumference of the intermediate transfer belt 20 constant.

Because the movement speed of the outer circumference of the intermediate transfer belt 20 is controlled to be constant as described above, the toner images are transferred accurately to the intermediate transfer belt 20, when the toner images are sequentially transferred in the form of layers from the four photosensitive drums 131 on which the toner images of the respective colors are formed in the image forming section 13 onto the intermediate transfer belt 20 (in order of M, C, Y and K in FIG. 1).

The toner images transferred to the intermediate transfer belt 20 are transferred to the paper P, when the paper P conveyed from the paper feed section 12 passes through the space between the secondary transfer roller 139 and the intermediate transfer belt 20 pressed in the outer circumferential direction by the pressing roller 23.

The paper P to which the toner images are transferred is introduced to the fixation section 14, and then the toner images are heated to be fixed to the paper P when the paper P passes through the space between the fixing roller 141 and the pressure roller 142. The paper P obtained the fixation processing moves up the paper ejection conveyance path 101 and is discharged to the catch tray 151 on the top of the printer 10 via the paper discharge port 152.

According to the embodiment described above, the speed of the outer circumferential surface of the intermediate transfer belt 20 to which the toner images are transferred can be measured accurately. As a result, the movement speed of the outer circumferential surface of the intermediate transfer belt 20 can be controlled with a high degree of accuracy, to transfer the toner images to the intermediate transfer belt 20 accurately. Thus, output with no density fluctuation or color registration error can be performed.

Although the above has described an embodiment of the present invention, the present invention is not limited to this embodiment, and therefore, for example, the following modifications are possible.

(1) The above embodiment described a printer as an example of the image forming apparatus of the present invention, but the image forming apparatus of the present invention is not necessarily a printer, but may be a copy machine, a facsimile device, a multifunction machine, or the like.

(2) In the embodiment, the intermediate transfer belt on which color images are formed in the form of layers is adopted as a transfer belt. However, in place of the intermediate transfer belt 20, a so-called paper conveyance belt that conveys paper to form a color image on the paper may be adopted as the transfer belt of the present invention.

Note that the invention having the following configuration is mainly included in the concrete embodiment described above.

An image forming apparatus according to one aspect of the present invention has: an image forming section that forms a toner image corresponding to image information; an intermediate transfer belt, which is an endless belt stretched between a plurality of rollers and traveling between the plurality of rollers, the toner image being transferred to a surface thereof or a recording sheet placed on the surface thereof; a driving roller, which is one of the plurality of rollers and drives the intermediate transfer belt; a bending roller, which touches an outer circumferential surface of the intermediate transfer belt and presses and bends the intermediate transfer belt in an inner circumferential direction; and a speed detecting part which detects a movement speed of an outer circumference of the intermediate transfer belt by measuring a rotational speed of the bending roller.

According to this configuration, because the speed of the intermediate transfer belt is obtained based on the rotational speed of the bending roller touching the outer circumferential surface of the intermediate transfer belt, the movement speed of not the inner circumference of the intermediate transfer belt but the outer circumference of the intermediate transfer belt to which the toner image is transferred can be detected.

In the configuration described above, the bending roller can be rotated about a rotation axis disposed in the center of the roller, and the speed detecting part may have an encoder plate installed concentrically with the rotation axis, and an optical sensor for measuring the rotational speed of the encoder plate. Such configuration makes it possible to detect the movement speed of the outer circumference of the intermediate transfer belt, by measuring the rotational speed of the bending roller by using the measured value of the rotational speed of the encoder plate.

According to this configuration, the rotational speed of the bending roller that is used for detecting the movement speed of the outer circumference of the intermediate transfer belt can be measured with the simple configuration with the encoder plate and optical sensor.

In the above configuration, it is desired that the image forming apparatus further have a controller for controlling the rotational speed of the driving roller to make the movement speed of the outer circumference of the intermediate transfer belt constant, when the speed detecting part detects a fluctuation in the movement speed of the outer circumference of the intermediate transfer belt.

According to this configuration, because the movement speed of the outer circumference of the intermediate transfer belt is made controlled to be constant, the toner image is transferred to the intermediate transfer belt accurately.

In the above configuration, the image forming apparatus can further have a primary transfer roller for transferring the toner image to the intermediate transfer belt, and a secondary transfer roller for transferring the toner image on the intermediate transfer belt to the recording sheet, wherein the plurality of rollers can include a support roller and a pressing roller in addition to the driving roller, the driving roller can touch an inner circumferential surface of the intermediate transfer belt, the support roller can touch the inner circumferential surface of the intermediate transfer belt and support the intermediate transfer belt while rotating following the rotation of the intermediate transfer belt, the primary transfer roller can be disposed between the driving roller and the support roller and touch the inner circumferential surface of the intermediate transfer belt, the image forming section can be disposed to face the primary transfer roller with the intermediate transfer belt interposed therebetween, the pressing roller can touch the inner circumferential surface of the intermediate transfer belt and form a secondary transfer nip part between the pressing roller and the secondary transfer roller, the intermediate transfer belt can perform circulating travel for traveling from the support roller to the driving roller and subsequently to the pressing roller and to the support roller again, and the bending roller can press and bend, in the inner circumferential direction, a part of the intermediate transfer belt that is stretched between the pressing roller and the support roller.

According to this configuration, a space can be formed on the side where the recording sheet having the toner image transferred thereto is conveyed out, by the bending roller pushing a part of the intermediate transfer belt inwardly. As a result, it is possible to create a space that is suitable for installing a fixation section or the like for fixing the toner image transferred to the recording sheet.

An image forming apparatus according to another aspect of the present invention has: an image forming section that forms a toner image corresponding to image information; an endless belt, which has a predetermined thickness and inner and outer circumferential surfaces facing each other, and in which the toner image is transferred to the outer circumferential surface; a driving roller that touches the inner circumferential surface of the endless belt and causes the inner circumferential surface of the endless belt to revolve at a first speed and the outer circumferential surface of the endless belt to revolve at a second speed higher than the first speed; a driven roller that touches the outer circumferential surface of the endless belt and rotates as the endless belt travels; and a speed detecting part that detects the second speed by measuring a rotational speed of the driven roller.

According to the present invention described above, because the speed of the intermediate transfer belt is obtained based on the rotational speed of the bending roller touching the outer circumferential surface of the intermediate transfer belt or of the driven roller, the movement speed of not the inner circumference of the intermediate transfer belt but the outer circumference of the intermediate transfer belt to which the toner image is transferred can be detected. As a result, the movement speed of the outer circumferential surface of the intermediate transfer belt can be controlled with a high degree of accuracy, and the toner image can be transferred to the intermediate transfer belt accurately. Therefore, an image forming apparatus capable of generating outputs with no density fluctuation or color registration error can be provided. Particularly, in a tandem system image forming apparatus for sequentially superposing toner images of the colors on the intermediate transfer belt and transferring these toner images, an output result with no color registration error can be achieved.

This application is based on Japanese patent application serial No. 2008-148448, filed in Japan Patent Office on Jun. 5, 2008, the contents of which is hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An image forming apparatus, comprising:
an image forming section that forms a toner image corresponding to image information;
an intermediate transfer belt, which is an endless belt stretched between a plurality of rollers and traveling between the plurality of rollers, the toner image being transferred to a surface thereof or a recording sheet placed on the surface thereof;
a driving roller, which is one of the plurality of rollers and drives the intermediate transfer belt;
a bending roller, which touches an outer circumferential surface of the intermediate transfer belt and presses and bends the intermediate transfer belt in an inner circumferential direction; and
a speed detecting part which detects a movement speed of an outer circumference of the intermediate transfer belt by measuring a rotational speed of the bending roller.

2. The image forming apparatus according to claim 1, wherein
the bending roller rotates about a rotation axis disposed in the center of the bending roller,
the speed detecting part has:
an encoder plate installed concentrically with the rotation axis; and
an optical sensor for measuring a rotational speed of the encoder plate, and
detects the movement speed of the outer circumference of the intermediate transfer belt by measuring a rotational speed of the bending roller using a measured value of the rotational speed of the encoder plate.

3. The image forming apparatus according to claim 1, further comprising:
a controller for controlling a rotational speed of the driving roller to make the movement speed of the outer circumference of the intermediate transfer belt constant, when the speed detecting part detects a fluctuation in the movement speed of the outer circumference of the intermediate transfer belt.

4. The image forming apparatus according to claim 1, further comprising:
a primary transfer roller for transferring the toner image to the intermediate transfer belt; and
a secondary transfer roller for transferring the toner image on the intermediate transfer belt to the recording sheet, wherein
the plurality of rollers comprises a support roller and a pressing roller in addition to the driving roller,
the driving roller touches an inner circumferential surface of the intermediate transfer belt,
the support roller touches the inner circumferential surface of the intermediate transfer belt and supports the intermediate transfer belt while rotating following the rotation of the intermediate transfer belt,
the primary transfer roller is disposed between the driving roller and the support roller and touches the inner circumferential surface of the intermediate transfer belt,
the image forming section is disposed to face the primary transfer roller with the intermediate transfer belt interposed therebetween,
the pressing roller touches the inner circumferential surface of the intermediate transfer belt and forms a secondary transfer nip part between the pressing roller and the secondary transfer roller,
the intermediate transfer belt performs circulating travel for traveling from the support roller to the driving roller and subsequently to the pressing roller and to the support roller again, and
the bending roller presses and bends, in the inner circumferential direction, a part of the intermediate transfer belt that is stretched between the pressing roller and the support roller.

5. An image forming apparatus, comprising:
an image forming section that forms a toner image corresponding to image information;
an endless belt, which has a predetermined thickness and inner and outer circumferential surfaces facing each other, and in which the toner image is transferred to the outer circumferential surface;
a driving roller that touches the inner circumferential surface of the endless belt and causes the inner circumferential surface of the endless belt to revolve at a first speed and the outer circumferential surface of the endless belt to revolve at a second speed higher than the first speed;
a driven roller that touches the outer circumferential surface of the endless belt and rotates as the endless belt travels; and
a speed detecting part that detects the second speed by measuring a rotational speed of the driven roller.
